(19) United States
(12) Patent Application Publication
(10) Pub. No.: US 2011/0039163 A1
(43) Pub. Date: Feb. 17, 2011

(54) NON-AQUEOUS ELECTROLYTE AND NON-AQUEOUS ELECTROLYTE SECONDARY BATTERY USING THE SAME

(76) Inventors: Masaki Deguchi, Hyogo (JP); Shinji Kasamatsu, Osaka (JP)

Correspondence Address: MCDERMOTT WILL & EMERY LLP, 600 13TH STREET, NW, WASHINGTON, DC, 20005-3096, US

(21) Appl. No.: 12/990,133

(22) PCT Filed: Mar. 23, 2010
(86) PCT No.: PCT/JP2010/002024

§ 371 Date: Oct. 28, 2010

(30) Foreign Application Priority Data
Mar. 31, 2009 (JP) 2009-086141

(51) Int. Cl. H01M 10/0566; H01M 4/485; H01M 4/505; H01M 4/52

(52) U.S. Cl. 429/330; 429/331; 429/332; 429/334; 429/231.3; 429/231.5; 429/231.6; 429/231.95; 429/221; 429/224

(57) ABSTRACT

Provided is a non-aqueous electrolyte capable of favorably suppressing the gas generation during storage in a high temperature environment and during charge/discharge cycling of a non-aqueous electrolyte secondary battery. The non-aqueous electrolyte includes a non-aqueous solvent and a solute dissolved in the non-aqueous solvent, wherein: the non-aqueous solvent includes ethylene carbonate, propylene carbonate, diethyl carbonate, and an additive; the additive includes a sultone compound and a cyclic carbonate having a C═C unsaturated bond; a weight percentage W_{PC} of the propylene carbonate relative to a total of the ethylene carbonate, propylene carbonate, and diethyl carbonate is 30 to 60% by weight; a ratio W_{PC}/W_{EC} of the weight percentage W_{PC} of the propylene carbonate to a weight percentage W_{EC} of the ethylene carbonate relative to the total satisfies 2.25≦W_{PC}/W_{EC}≦6; and a ratio W_{C}/W_{SL}, of a weight percentage W_{C} of the cyclic carbonate having a C═C unsaturated bond to a weight percentage W_{SL} of the sultone compound satisfies 0.5≦W_{C}/W_{SL}≦3.

### TECHNICAL FIELD

The present invention relates to a non-aqueous electrolyte and a non-aqueous electrolyte secondary battery, and particularly relates to a composition of a non-aqueous electrolyte.

### BACKGROUND ART

Non-aqueous electrolyte for non-aqueous electrolyte secondary batteries represented by lithium ion secondary batteries includes a non-aqueous solvent and a solute dissolved in the non-aqueous solvent. For the solute, for example, lithium hexafluorophosphate (LiPF₆) and lithium tetrafluoroborate (LiBF₄) are used.

The non-aqueous solvent includes a linear carbonate or a cyclic carbonate. Examples of the linear carbonate include diethyl carbonate (DEC). Examples of the cyclic carbonate include ethylene carbonate (EC), propylene carbonate (PC) and vinylene carbonate (VC). Other than the above non-aqueous solvent, non-aqueous solvents including a cyclic carboxylic acid ester, a linear ether, a cyclic ether, or the like are also commonly used.

Patent Literature 1 discloses a non-aqueous electrolyte including a non-aqueous solvent containing PC, vinylene carbonate (VC) and 1,3-propane sultone (PS), to which EC and DEC are further added.

Patent Literature 2 discloses a non-aqueous electrolyte secondary battery in which the ratio of EC to PC is 1:1. Patent Literature 2 discloses using mesocarbon microbeads (MCMB) as the negative electrode active material.

Patent Literature 3 discloses a non-aqueous electrolyte containing PC in an amount of 40% by volume or more, and vinylene carbonate in an amount of less than 5% by volume.

### CITATION LIST

### Patent Literature

### [PTL 1] Japanese Laid-Open Patent Publication No. 2004-355974

### [PTL 2] Japanese Laid-Open Patent Publication No. 2006-221935

### [PTL 3] Japanese Laid-Open Patent Publication No. 2003-168477

### SUMMARY OF INVENTION

### Technical Problem

Patent Literature 1 discloses in Examples a non-aqueous electrolyte satisfying EC:PC:DEC=10:20:70. DEC is susceptible to oxidative decomposition and reductive decomposition. Because of this, when the weight percentage of DEC is very high as in the above non-aqueous electrolyte, a large amount of gas is generated during storage in a high temperature environment or charge/discharge cycling, causing the charge/discharge capacity of the battery to decrease.

The non-aqueous electrolyte of Patent Literature 2 does not contain DEC and thus is highly viscous. When the viscosity of the non-aqueous electrolyte is high, the non-aqueous electrolyte not only becomes less likely to permeate into the electrode plate but also becomes less ionically conductive. As a result, the rate characteristics particularly at low temperatures tend to deteriorate.

Further, VC forms a surface film on the negative electrode, but is easily decomposed by oxidation at the positive electrode. Accordingly, in the battery of Patent Literature 3, the amount of gas generated as a result of oxidative decomposition of VC at the positive electrode is particularly increased.

In view of the above problems, the present invention intends to provide a non-aqueous electrolyte capable of suppressing the gas generation in a non-aqueous electrolyte secondary battery during storage in a high temperature environment or during charge/discharge cycling. Further, the present invention intends to provide, by using the above non-aqueous electrolyte, a non-aqueous electrolyte secondary battery being excellent in storage characteristics in a high temperature environment and charge/discharge cycle characteristics, and having excellent low temperature characteristics.

### Solution to Problem

The present invention provides a non-aqueous electrolyte including a non-aqueous solvent and a solute dissolved in the non-aqueous solvent, wherein: the non-aqueous solvent includes ethylene carbonate, propylene carbonate, diethyl carbonate, and an additive; the additive includes a sultone compound and a cyclic carbonate having a C═C unsaturated bond; the weight percentage W_{PC} of the propylene carbonate relative to a total of the ethylene carbonate, the propylene carbonate, and the diethyl carbonate is 30 to 60% by weight; a ratio W_{PC}/W_{EC} of the weight percentage W_{PC} of the propylene carbonate to a weight percentage W_{EC} of the ethylene carbonate relative to the total satisfies 2.25≦W_{PC}/W_{EC}≦6; and a ratio W_{C}/W_{SL} of a weight percentage W_{C} of the cyclic carbonate having a C═C unsaturated bond to a weight percentage W_{SL} of the sultone compound satisfies 0.5≦W_{C}/W_{SL}≦3.

The present invention further provides a non-aqueous electrolyte secondary battery obtained by: forming an electrode assembly including a positive electrode, a negative electrode, and a separator; encasing the electrode assembly in a battery case; injecting the above non-aqueous electrolyte into the battery case with the electrode assembly encased therein, and sealing the battery case to prepare an initial battery, followed by allowing the initial battery to be subjected to at least one charge/discharge cycle, wherein the negative electrode includes a negative electrode core material and a negative electrode material mixture layer attached on the negative electrode core material, and the negative electrode material mixture layer includes graphite particles, a water-soluble polymer coated on a surface of the graphite particles, and a binder providing adhesion between the graphite particles coated with the water-soluble polymer.

### ADVANTAGEOUS EFFECTS OF INVENTION

According to the present invention, the gas generation in a non-aqueous electrolyte secondary battery during storage in a high temperature environment or during charge/discharge cycling can be favorably suppressed. By using the non-aqueous electrolyte of the present invention, it is possible to provide a non-aqueous electrolyte secondary battery being excellent in storage characteristics in a high temperature environment and charge/discharge cycle characteristics, and having excellent low temperature characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 A longitudinal cross-sectional view schematically showing an example of a non-aqueous electrolyte secondary battery according to the present invention.

### DESCRIPTION OF EMBODIMENT

In the non-aqueous electrolyte of the present invention, the non-aqueous solvent includes ethylene carbonate (EC), propylene carbonate (PC), diethyl carbonate (DEC), and an additive, the additive including a sultone compound and a cyclic carbonate having a C═C unsaturated bond. In the present invention, the weight percentage W_{PC} of PC relative to the total of EC, PC, and DEC is 30 to 60% by weight.

In a non-aqueous electrolyte including EC, PC and DEC, when the weight percentage of EC is relatively large, oxidative decomposition of EC occurs particularly at the positive electrode, and thus the amount of generated gas such as CO and CO₂ is increased. Further, the freezing point of the non-aqueous electrolyte is raised, and thus the rate characteristics particularly at low temperatures deteriorate.

In a non-aqueous electrolyte including EC, PC and DEC, when the weight percentage of DEC is relatively high, oxidative decomposition and reductive decomposition of DEC occur at the positive electrode and the negative electrode, and thus the amount of generated gas such as CO, CO₂, CH₄, and C₂H₆ is increased.

As such, by setting the amounts of EC and DEC in the non-aqueous solvent to be relatively small, the amount of gas generated by oxidative decomposition of EC and oxidative decomposition and reductive decomposition of DEC is significantly reduced.

According to the present invention, in a non-aqueous electrolyte including EC, PC and DEC, the weight percentage of PC is set to be relatively high, specifically, to 30 to 60% by weight. By doing this, the gas generation caused by oxidation and reduction of DEC and oxidation of EC can be suppressed.

Cyclic carbonates such as PC and EC have oxidation potentials higher than linear carbonates such as DEC. Because of this, cyclic carbonates are less likely to be decomposed by oxidation than linear carbonates. Among the cyclic carbonates, PC (melting point: −49° C.) has a melting point lower than EC (melting point: 37° C.), and therefore, is advantageous in terms of the low-temperature characteristics of non-aqueous electrolyte secondary batteries.

In the non-aqueous electrolyte of the present invention, the ratio W_{PC}/W_{EC} of the weight percentage W_{PC} of the propylene carbonate to the weight percentage W_{EC} of the ethylene carbonate satisfies 2.25≦W_{PC}/W_{EC}≦6.

When the W_{PC}/W_{EC} is less than 2.25, there is a possibility that the amount of gas generated by oxidative decomposition of EC at the positive electrode is increased. When the W_{PC}/W_{EC} exceeds 6, there is a possibility that the amount of gas generated by reductive decomposition of PC at the negative electrode is increased. More preferably, the ratio W_{PC}/W_{EC} of the weight percentage W_{PC} of the propylene carbonate to the weight percentage W_{EC} of the ethylene carbonate satisfies 3≦W_{PC}/W_{EC}≦5.

The ratio of the weight percentages of EC, PC and DEC is preferably such that W_{EC}:W_{PC}:W_{DEC}=1:3 to 6:3 to 6, more preferably 1:3.5 to 5.5:3.5 to 5.5, and particularly preferably 1:5:4. In a non-aqueous electrolyte in which the ratio of the weight percentages of EC, PC and DEC is within the foregoing range, the weight percentage ratio of PC is high, and the weight percentage ratios of EC and DEC are comparatively low. As such, the amounts of gas generated by oxidative decomposition or reductive decomposition of EC and DEC can be greatly reduced.

The weight percentage W_{PC} of PC relative to the total of EC, PC and DEC is 30 to 60% by weight, and preferably 35 to 55% by weight. When the weight percentage of PC is less than 30% by weight, the amounts of DEC and EC in the non-aqueous solvent are relatively large, which may possibly result in inefficient suppression of gas generation. Moreover, the amount of PC is relatively small, which may possibly result in inefficient improvement of the low-temperature characteristics. When the weight percentage of PC exceeds 60% by weight, there is a possibility that reductive decomposition of PC occurs at the negative electrode, generating gas such as CH₄, C₃H₆ and C₃H₈. By setting the weight percentage of PC in the non-aqueous solvent to be within the foregoing ranges, the amount of generated gas derived from EC and DEC can be reduced, and the reductive decomposition of PC can be inhibited. It is possible, therefore, to remarkably suppress the reduction of the charge/discharge capacity of non-aqueous electrolyte secondary batteries in a high temperature environment, and the reduction of the discharge characteristics at low temperatures.

The weight percentage W_{EC} of EC relative to the total of EC, PC and DEC is preferably 5 to 20% by weight, and more preferably 10 to 15% by weight. When the weight percentage of EC is less than 5% by weight, there is a possibility that a surface film, which is known as a solid electrolyte interface (SEI), is not sufficiently formed on the negative electrode, causing lithium ions to be less likely to be absorbed or desorbed to and from the negative electrode. When the weight percentage of EC exceeds 20% by weight, there is a possibility that oxidative decomposition of EC occurs particularly at the positive electrode, and thus the amount of generated gas is increased. By setting the weight percentage of EC in the non-aqueous solvent to be within the foregoing ranges, the amount of gas generated by oxidative decomposition of EC can be reduced, and a surface film can be sufficiently formed on the negative electrode. It is possible, therefore, to significantly improve the charge/discharge capacity and rate characteristics of non-aqueous electrolyte secondary batteries.

The weight percentage W_{DEC} of DEC relative to the total of EC, PC and DEC is preferably 30 to 65% by weight, and more preferably 35 to 55% by weight. When the weight percentage of DEC is less than 30% by weight, there is a possibility that the discharge characteristics at low temperatures easily deteriorate. When the weight percentage of DEC exceeds 65% by weight, there is a possibility that a larger amount of gas is generated.

The non-aqueous electrolyte of the present invention includes an additive including a sultone compound and a cyclic carbonate having a C═C unsaturated bond. The ratio W_{C}/W_{SL}, of a weight percentage W_{C} of the cyclic carbonate having a C═C unsaturated bond to a weight percentage W_{SL} of the sultone compound in the additive satisfies 0.5≦W_{C}/W_{SL}≦3. When the W_{C}/W_{SL}, is less than 0.5, there is a possibility that an SEI is not sufficiently formed. There also is a possibility that a surface film derived from the sultone compound is excessively formed on the negative electrode, preventing a sufficient formation of an SEI derived from the cyclic carbonate having a C═C unsaturated bond on the negative electrode. This may result in deterioration in the charge acceptance, increasing the possibility of deterioration in the cycle characteristics. This also may result in an increase in the resistance of the surface film on the negative electrode, causing the discharge characteristics at low temperatures to deteriorate.

When the W_{C}/W_{SL} exceeds 3, there is a possibility that oxidative decomposition of the cyclic carbonate having a C═C unsaturated bond occurs, thus generating a larger amount of gas. There also is a possibility of failing to sufficiently bring about the effects of the sultone compound to inhibit the reductive decomposition of PC at the negative electrode and to inhibit the oxidative decomposition of the cyclic carbonate having a C═C unsaturated bond at the positive electrode. This may result in generation of a larger amount of gas. More preferably, the W_{C}/W_{SL} satisfies 0.75≦W_{C}/W_{SL}≦1.5.

When the additive includes the cyclic carbonate having a C═C unsaturated bond, a surface film is mainly formed on the negative electrode, inhibiting the decomposition of the non-aqueous electrolyte.

Examples of the cyclic carbonate having a C═C unsaturated bond include vinylene carbonate (VC), vinylethylene carbonate (VEC), and divinylethylene carbonate (DVEC). These cyclic carbonates having a C═C unsaturated bond may be used singly or in combination of two or more. Among these, vinylethylene carbonate is preferably included in the additive because a thin and dense surface film is formed on the negative electrode and the resistance of the formed surface film is low.

When the additive includes the sultone compound, the formation of a surface film on both the positive electrode and the negative electrode is enabled. This is preferable because a surface film formed on the positive electrode can inhibit the oxidative decomposition of the non-aqueous solvent at the positive electrode in a high temperature environment, and a surface film formed on the negative electrode can inhibit the reductive decomposition of the non-aqueous solvent, particularly of PC, at the negative electrode.

Examples of the sultone compound include 1,3-propane sultone (PS), 1,4-butane sultone, and 1,3-propene sultone (PRS). These sultone compounds may be used singly or in combination of two or more. Among these, 1,3-propane sultone is preferably included in the additive because the effect of inhibiting the reductive decomposition of PC can be enhanced.

Particularly preferred among the above is including both vinylene carbonate and 1,3-propane sultone in the additive. By doing this, on the positive electrode, a surface film derived from the 1,3-propane sultone is formed; and on the negative electrode, a surface film derived from the vinylene carbonate and a surface film derived from the 1,3-propane sultone are formed. The surface film derived from the vinylene carbonate can minimize the increase in the film resistance, thus improving the charge acceptance. This can suppress the deterioration in the cycle characteristics. The surface film derived from the 1,3-propane sultone can inhibit the reductive decomposition of PC, thus suppressing the generation of gas such as CH₄, C₃H₆, and C₃H₈.

In the case of adding vinylene carbonate only, there is a possibility that the vinylene carbonate, because of its poor oxidation resistance, is decomposed by oxidation at the positive electrode, thus generating a larger amount of CO₂ gas. By adding vinylene carbonate in combination with 1,3-propane sultone, a surface film derived from the 1,3-propane sultone is also formed on the positive electrode, which can inhibit the oxidative decomposition of the non-aqueous solvent as well as of the vinylene carbonate. As a result, the generation of gas such as CO₂ can be significantly suppressed.

The amount of the additive, namely, the total amount of the sultone compound and the cyclic carbonate having a C═C unsaturated bond, is preferably 1.5 to 5% by weight and more preferably 2 to 4% by weight of the whole amount of the non-aqueous electrolyte. When the total amount of the sultone compound and the cyclic carbonate having a C═C unsaturated bond is less than 1.5% by weight of the whole amount of the non-aqueous electrolyte and when the non-aqueous electrolyte includes EC, PC and DEC, there is a possibility that the reductive decomposition of PC is not sufficiently inhibited. When the total amount of the sultone compound and the cyclic carbonate having a C═C unsaturated bond exceeds 5% by weight of the whole amount of the non-aqueous electrolyte, and when the non-aqueous electrolyte includes EC, PC and DEC, there is a possibility that a surface film is excessively formed on the negative electrode, and the absorption/desorption reaction of lithium ions is inhibited, causing the charge acceptance to be insufficient.

The additive is not limited to the sultone compound and the cyclic carbonate having a C═C unsaturated bond as described above, and may additionally include other compounds. Examples of these other compounds include, without any particular limitation, cyclic sulfones such as sulfolane, fluorine-containing compounds such as fluorinated ether, and cyclic carboxylic acid esters such as γ-butyrolactone. The weight percentage of the additives of these other compounds in the whole non-aqueous electrolyte is preferably 10% by weight or less. These other additives may be used singly or in combination of two or more.

The viscosity at 25° C. of the non-aqueous electrolyte of the present invention is, for example, 4 to 6.5 cP. By setting the viscosity within this range, it is possible to minimize the reduction in the rate characteristics, in particular, the reduction in the rate characteristics at low temperatures. The viscosity of the non-aqueous electrolyte can be controlled by, for example, changing the weight percentage of the linear carbonate such as DEC. The viscosity is measured with a rotational viscometer and a cone plate spindle.

Examples of the solute of the non-aqueous electrolyte include, without any particular limitation, inorganic lithium fluorides such as LiPF₆ and LiBF₄, and lithium imide compounds such as LiN(CF₃SO₂)₂ and LiN(C₂F₅SO₂)₂.

The non-aqueous electrolyte secondary battery of the present invention is produced by using the above-described non-aqueous electrolyte. The battery includes a positive electrode, a negative electrode, and a separator interposed between the positive electrode and the negative electrode.

The above battery is obtained by, for example, a production method including the steps of:

(1) forming an electrode assembly including a positive electrode, a negative electrode, and a separator;

(2) encasing the electrode assembly in a battery case, and then injecting the above-described non-aqueous electrolyte into the battery case with the electrode assembly encased therein;

(3) sealing the battery case after the step (2); and

(4) allowing an initial battery obtained in the step (3) to be subjected to at least one charge/discharge cycle.

According to the non-aqueous electrolyte secondary battery of the present invention, the gas generation caused by the reaction between the non-aqueous electrolyte and the positive or negative electrode is significantly suppressed, and thus the reduction in the charge/discharge capacity and the deterioration in the rate characteristics can be minimized. It should be noted that the sultone compound and/or the cyclic carbonate having a C═C unsaturated bond included in the additive are partially decomposed, forming a surface film on the positive electrode and/or the negative electrode. Accordingly, the W_{C}/W_{SL} in the non-aqueous electrolyte when included in the battery changes to, for example, 0.2 to 6. Further, the amount of the additive in the non-aqueous electrolyte when included in the battery changes to, for example, 0.1 to 4.5% by weight.

The negative electrode includes a negative electrode core material and a negative electrode material mixture layer adhered onto the negative electrode core material. In the present invention, it is preferable that the negative electrode material mixture layer includes graphite particles, a water-soluble polymer coated on the surfaces of the graphite particles, and a binder for bonding together the graphite particles coated with the water-soluble polymer.

The non-aqueous electrolyte of the present invention in which the weight percentage of PC is high can suppress the generation of gas derived from EC and DEC as described above, but has a possibility of generating gas due to the reductive decomposition of PC. In view of this, graphite particles coated with a water-soluble polymer are used, thereby to more significantly suppress the gas generation at the negative electrode caused by the reductive decomposition of PC. Using graphite coated with a water-soluble polymer is also effective in reducing the occurrence of co-intercalation of PC and Li ions, which are in a solvated state, between the layers of graphite. As such, the destruction of the layer structure due to deterioration of the graphite edges and the reductive decomposition of PC at the negative electrode are greatly suppressed.

In addition, by coating the surface of the negative electrode active material with a water-soluble polymer with good swelling property such as carboxymethyl cellulose (CMC), permeation of the non-aqueous electrolyte including vinylene carbonate and 1,3-propane sultone into the interior of the negative electrode is facilitated. Consequently, the non-aqueous electrolyte can be almost uniformly present on the surfaces of the graphite particles, allowing a surface film to be easily formed on the negative electrode uniformly without unevenness during initial charging. As a result, the charge acceptance is improved, and the reductive decomposition of PC is favorably suppressed. In short, when a water-soluble polymer and the above-described non-aqueous electrolyte are used in combination, the gas generation can be greatly suppressed as compared to when either one of them is used alone.

The negative electrode preferably includes graphite particles as a negative electrode active material. The graphite particles as used herein are particles including a region having a graphite structure which are collectively known as graphite particles. Accordingly, the graphite particles include natural graphite particles, artificial graphite particles, and graphitized mesophase carbon particles.

Diffraction figures of the graphite particles measured by a wide-angle X-ray diffraction method have a peak attributed to the (101) plane and a peak attributed to the (100) plane. Here, the ratio of a peak intensity I(101) attributed to the (101) plane to a peak intensity I(100) attributed to the (100) plane preferably satisfies 0.01<I(101)/I(100)<0.25, and more preferably satisfies 0.08<I(101)/I(100)<0.2. The peak intensity means the height of a peak.

The average particle diameter of the graphite particles is preferably 14 to 25 μm, and more preferably 16 to 23 μm. When the average particle diameter is within the foregoing ranges, the slidability of the graphite particles in the negative electrode material mixture layer improves, and the packed state of the graphite particles becomes favorable, which is advantageous in enhancing the adhesion strength between the graphite particles. The average particle diameter means a median diameter (D50) in a volumetric particle size distribution of the graphite particles. The volumetric particle size distribution of the graphite particles can be measured with, for example, a commercially available laser diffraction-type particle size distribution analyzer.

The average circularity of the graphite particles is preferably 0.9 to 0.95, and more preferably 0.91 to 0.94. When the average circularity is within the foregoing ranges, the slidability of the graphite particles in the negative electrode material mixture layer improves, which is advantageous in improving the packed state of the graphite particles and enhancing the adhesion strength between the graphite particles. The average circularity is represented by 4 πS/L², where S is an area of an orthographic projection image of the graphite particle, and L is a circumferential length of the orthographic projection image. For example, it is preferable that the average circularity of arbitrarily selected 100 graphite particles is within the foregoing ranges.

The specific surface area S of the graphite particles is preferably 3 to 5 m²/g, and more preferably 3.5 to 4.5 m²/g. When the specific surface area is within the foregoing ranges, the slidability of the graphite particles in the negative electrode material mixture layer improves, which is advantageous in enhancing the adhesion strength between the graphite particles. In addition, the preferred amount of the water-soluble polymer required for coating the surfaces of the graphite particles can be reduced.

The surfaces of the graphite particles are coated with a water-soluble polymer. It is not necessary here that the surface of each graphite particle is completely coated, and it suffices if the surface is partially coated. It should be noted, however, that the graphite particles of the present invention is coated with a water-soluble polymer to a higher degree than the conventional ones.

The degree of coating by the water-soluble polymer on the surfaces of the graphite particles (hereinafter the “coating rate”) can be evaluated by thermogravimetry/differential thermal analysis (TG-DTA). According to TG-DTA, the change in mass of a sample when heated at a predetermined temperature elevation rate can be continuously measured with respect to the time or temperature. In analyzing the graphite particles coated with a water-soluble polymer by TG-DTA, the decrease in weight of the water-soluble polymer associated with pyrolysis is observed while the temperature is elevated. The higher the percentage of the area coated with the water-soluble polymer on the surfaces of the graphite particles is, and the higher the coating rate is, the higher the weight reduction rate of the graphite particles measured by TG-DTA is. This means that the coating amount of the water-soluble polymer on the surfaces of the graphite particles and the coating rate can be evaluated on the basis of the weight reduction rate.

The degree of coating by the water-soluble polymer on the surfaces of the graphite particles can also be measured on the basis of the penetration rate of water into the negative electrode material mixture layer. The penetration rate of water into the negative electrode material mixture layer is preferably 3 to 40 seconds. A negative electrode active material exhibiting such a water penetration rate is in an appropriately coated state. As such, the permeation of the non-aqueous electrolyte including the additive into the interior of the negative electrode is facilitated. This can more favorably suppress the reductive decomposition of PC. The penetration rate of water into the negative electrode material mixture layer is more preferably 10 to 25 seconds.

The penetration rate of water into the negative electrode material mixture layer can be measured by, for example, the method as described below.

First, 2 μl, of water is dropped, to allow a water droplet to be in contact with the surface of the negative electrode material mixture layer. Then, the time period until the contact angle θ of water with respect to the surface of the negative electrode material mixture layer is reduced to be less than 10° is measured to determine a penetration rate of water into the negative electrode material mixture layer. The contact angle of water with respect to the surface of the negative electrode material mixture layer may be measured with a commercially available contact angle meter (e.g., DM-301 available from Kyowa Interface Science Co., Ltd.).

In order to coat the surfaces of the graphite particles with a water-soluble polymer, the negative electrode is preferably produced in the production method as described below. Methods A and B are described here as exemplary production methods.

The method A is described first.

The method A includes a step of mixing graphite particles, water, and a water-soluble polymer being dissolved in water, and drying the resultant mixture, to give a dry mixture (step (i)). For example, a water-soluble polymer is dissolved in water, to prepare an aqueous solution of the water-soluble polymer. The obtained aqueous solution of the water-soluble polymer is mixed with graphite particles, and then, water is removed therefrom to dry the mixture. By preliminarily drying the mixture as above, the water-soluble polymer is efficiently adhered onto the surfaces of the graphite particles, and thus the coating rate by the water-soluble polymer on the surfaces of the graphite particles is increased.

The viscosity at 25° C. of the aqueous solution of the water-soluble polymer is preferably controlled to 1000 to 10000 cP. The viscosity is measured with a B type viscometer at a circumferential velocity of 20 mm/s using a 5-mm-diameter spindle. The amount of the graphite particles to be mixed with 100 parts by weight of the aqueous solution of the water-soluble polymer is preferably 50 to 150 parts by weight.

The drying temperature of the mixture is preferably 80 to 150° C., and the drying time thereof is preferably 1 to 8 hours.

Subsequently, the obtained dry mixture is mixed with a binder and a liquid component, to prepare a negative electrode material mixture slurry (step (ii)). By performing this step, the binder is adhered onto the surfaces of the graphite particles coated with the water-soluble polymer. Since the slidability between the graphite particles is good, the binder adhered onto the surfaces of the graphite particles coated with the water-soluble polymer is subjected to sufficient shear force and thus effectively acts on the surfaces of the graphite particles.

The obtained negative electrode material mixture slurry is applied onto a negative electrode core material and dried, to form a negative electrode material mixture layer, whereby a negative electrode is obtained (step (iii)). The method of applying the negative electrode material mixture slurry onto the negative electrode core material is not particularly limited. For example, the negative electrode material mixture slurry is applied at a predetermined pattern onto a raw sheet of the negative electrode core material with a die coater. The drying temperature of the applied film is also not particularly limited. The applied film after drying is rolled with press rolls, to have a predetermined thickness. As a result of the rolling, the adhering strength between the negative electrode material mixture layer and the negative electrode core material and the adhering strength between the graphite particles are enhanced. The negative electrode material mixture layer thus obtained is cut together with the negative electrode core material into a predetermined shape, whereby the negative electrode is completed.

Secondly, the method B is described.

The method B includes a step of mixing graphite particles, a binder, water, and a water-soluble polymer being dissolved in the water, and drying the resultant mixture, to give a dry mixture (step (i)). For example, a water-soluble polymer is dissolved in water, to prepare an aqueous solution of the water-soluble polymer. The viscosity of the aqueous solution of the water-soluble polymer is controlled to be the same as that in the method A. The obtained aqueous solution of the water-soluble polymer is mixed with a binder and graphite particles, and then, water is removed therefrom to dry the mixture. By preliminarily drying the mixture as above, the water-soluble polymer and the binder are efficiently adhered onto the surfaces of the graphite particles. As such, the coating rate by the water-soluble polymer on the surfaces of the graphite particles is increased, and the binder is adhered in a favorable state onto the surfaces of the graphite particles coated with the water-soluble polymer. In view of improving the dispersibility of the binder in the aqueous solution of the water-soluble polymer, it is preferable to mix the binder in the form of fluid dispersion in which the dispersion medium is water, with the aqueous solution of the water-soluble polymer.

Subsequently, the obtained dry mixture is mixed with a liquid component, to prepare a negative electrode material mixture slurry (step (ii)). By performing this step, the graphite particles coated with the water-soluble polymer and the binder swell to some extent with the liquid component, and the slidability between the graphite particles becomes good.

The obtained negative electrode material mixture slurry is applied onto a negative electrode core material, dried, rolled and formed into a negative electrode material mixture layer in the same manner as in the method A, whereby a negative electrode is obtained (step (iii)).

The liquid component to be used in preparing the negative electrode material mixture slurry in the methods A and B is not particularly limited, but is preferably, for example, water or an aqueous alcohol solution, among which water is most preferred. N-methyl-2-pyrrolidone (hereinafter “NMP”) or the like may also be used.

The water-soluble polymer may be of any type, without any particular limitation, and for example, may be cellulose, polyacrylic acid, polyvinyl alcohol, polyvinylpyrrolidone, and derivatives of the above polymers. Among these, cellulose, a cellulose derivative, and polyacrylic acid are preferred. Preferred examples of the cellulose derivative include methylcellulose, carboxymethyl cellulose, and Na salts of carboxymethyl cellulose. The molecular weights of the cellulose and the cellulose derivative are preferably 10,000 to 1,000,000. The molecular weight of the polyacrylic acid is preferably 5,000 to 1,000,000.

The amount of the water-soluble polymer included in negative electrode material mixture layer is preferably 0.5 to 2.5 parts by weight per 100 parts by weight of the graphite particles, more preferably 0.5 to 1.5 parts by weight, and particularly preferably 0.5 to 1.0 part by weight. When the amount of the water-soluble polymer is within the foregoing ranges, the water-soluble polymer can be coated on the surfaces of the graphite particles at a high coating rate. In addition, the surfaces of the graphite particles are not excessively coated with the water-soluble polymer, and thus the increase in the internal resistance of the negative electrode is minimized.

The binder to be included in the negative electrode material mixture layer is not particularly limited, but is preferably a particulate binder with rubber elasticity. The average particle diameter of the particulate binder is preferably 0.1 μm to 0.3 μm, and more preferably 0.1 to 0.26 μm, particularly preferably 0.1 to 0.15 μm, and most preferably 0.1 to 0.12 μm. The average particle diameter of the binder is measured by, for example, obtaining SEM photographs of ten binder particles by using a transmission electron microscope (available from JEOL Ltd., acceleration voltage 200 kV), and averaging the maximum diameters of these ten binder particles.

A particularly preferable particulate binder with rubber elasticity having an average particle diameter of 0.1 μm to 0.3 μm is a polymer having styrene units and butadiene units. Such a polymer is highly elastic and is stable at a negative electrode potential.

The amount of the binder in the negative electrode material mixture layer is preferably 0.4 to 1.5 parts by weight per 100 parts by weight of the graphite particles, more preferably 0.4 to 1 part by weight, and particularly preferably 0.4 to 0.7 parts by weight. When the surfaces of the graphite particles are coated with the water-soluble polymer, the slidability between the graphite particles is good. As such, the binder adhered onto the surfaces of the graphite particles coated with the water-soluble polymer is subjected to sufficient shear force and thus effectively acts on the surfaces of the graphite particles. Further, when the binder is particulate and small in average particle diameter, the probability that the binder comes in contact with the surfaces of the graphite particles coated with the water-soluble polymer is increased. As such, the binder, even when the amount thereof is small, can exhibit sufficient binding ability.

For the negative electrode core material, for example, a metallic foil is used. In producing a negative electrode for lithium ion secondary batteries, for example, copper foil or copper alloy foil is generally used as the negative electrode core material. Among these, copper foil (which may contain other components except copper in an amount of 0.2 mol % or less) is preferred, and electrolytic copper foil is particularly preferred.

For the positive electrode, any positive electrode may be used without any particular limitation, as long as it can be used as a positive electrode for non-aqueous electrolyte secondary batteries. The positive electrode is obtained by, for example, applying a positive electrode material mixture slurry including a positive electrode active material, a conductive agent such as carbon black, and a binder such as polyvinylidene fluoride onto a positive electrode core material such as aluminum foil, followed by drying and rolling. For the positive electrode active material, a composite oxide including lithium and a transition metal is preferred. Typical examples of the composite oxide including lithium and a transition metal include LiCoO₂, LiMn₂O₄, LiMnO₂, and LiₓNi_{y}M_{z}Me_{1-(y+z)}O_{2+d}.

Above all, the positive electrode preferably includes a composite oxide containing lithium and nickel, in view of achieving a high capacity as well as more effectively suppressing the gas generation. In this case, the mole ratio of nickel to lithium in the composite oxide is preferably 30 to 100 mol %.

Preferably, the composite oxide further contains at least one selected from the group consisting of manganese and cobalt, and the mole ratio of the total of manganese and cobalt to lithium is preferably 70 mol % or less.

Preferably, the composite oxide furthermore contains element Me other than Li, Ni, Mn, Co and O, and the mole ratio of element Me to lithium is preferably 1 to 10 mol %.

The positive electrode more preferably includes a composite oxide represented by the general formula (1):

LiₓNi_{y}M_{z}Me_{1-(y+z)}O_{2+d} (1),

where M is at least one element selected from the group consisting of Co and Mn; Me is at least one element selected from the group consisting of Al, Cr, Fe, Mg and Zn; 0.98≦x≦1.1; 0.3≦y≦1; 0≦z≦0.7; 0.9≦(y+z)≦1; and −0.01≦d≦0.01.

The above composite oxide is known as a material that has a high capacity but generally generates a comparatively large amount of gas. However, in the case of using it in combination with the non-aqueous electrolyte of the present invention in which the content of EC is small, a surface film derived from the sultone compound is formed on the positive electrode, and therefore, the amount of generated gas is significantly reduced.

For the separator, a microporous film made of polyethylene, polypropylene or the like is generally used. The thickness of the separator is, for example, 10 to 30

The present invention is applicable to non-aqueous electrolyte secondary batteries of various shapes, such as batteries of cylindrical shape, flat shape, coin shape, and prismatic shape, without any particular limitation to the shape of the battery.

The present invention is specifically described below with reference to examples and comparative examples. It should be noted, however, the present invention is not limited to the following examples.

### EXAMPLES

### Example 1

### (a) Production of Negative Electrode

Step (i)

First, carboxymethyl cellulose (hereinafter “CMC”, molecular weight: 400,000) being a water-soluble polymer was dissolved in water, to prepare an aqueous solution in which the CMC concentration was 1.0% by weight. Subsequently, 100 parts by weight of natural graphite particles (average particle diameter: 20 μm, average circularity: 0.92, specific surface area: 4.2 m²/g) and 100 parts by weight of the CMC aqueous solution were mixed together, and stirred while the temperature of the mixture was controlled at 25° C. Thereafter, the mixture was dried at 120° C. for 5 hours, to give a dry mixture. In the dry mixture, the amount of the CMC per 100 parts by weight of the graphite particles was 1.0 part by weight.

Step (ii)

The obtained dry mixture was mixed in an amount of 101 parts by weight with 0.6 parts by weight of a particulate binder with rubber elasticity having an average particle diameter of 0.12 μm and having styrene units and butadiene units (hereinafter “SBR”), 0.9 parts by weight of carboxymethyl cellulose, and an appropriate amount of water, to prepare a negative electrode material mixture slurry. Here, in mixing the SBR with the other components, the SBR was in the form of emulsion in which the dispersion medium was water (BM-400B (trade name) available from Zeon Corporation, Japan, weight percentage of SBR: 40 wt %).

Step (iii)

The prepared negative electrode material mixture slurry was applied onto both surfaces of an electrolytic copper foil (thickness: 12 μm) serving as the negative electrode core material by using a die coater, and the applied film was dried at 120° C. Thereafter, the dried applied film was rolled between press rollers at a line pressure of 0.25 ton/cm, to form a negative electrode material mixture layer having a thickness of 160 μm and having a graphite density of 1.65 g/cm³. The negative electrode material mixture layer was cut together with the negative electrode core material into a predetermined shape, to produce a negative electrode.

The penetration rate of water into the negative electrode material mixture layer was measured in the manner as described below.

First, 2 μL of water was dropped, to allow a water droplet to be in contact with the surface of the negative electrode material mixture layer. Then, the time period until the contact angle θ of water with respect to the surface of the negative electrode material mixture layer was reduced to be less than 10° was measured with a contact angle meter (DM-301 available from Kyowa Interface Science Co., Ltd.). The measured penetration rate of water into the negative electrode material mixture layer was 15 seconds.

In addition, the dry mixture obtained in the step (i) was subjected to TG-DTA analysis under the following conditions. The measured weight reduction rate of the dry mixture was 0.99%.

Instrument: ThermoPlus2 available from Rigaku Corporation

Standard sample: Alumina

Temperature elevation condition: Elevated from room temperature to 700° C.

Temperature elevation rate: 10° C./min

Measurement atmosphere: Ar

Sample weight: Approx. 10 mg

### (b) Production of Positive Electrode

To 100 parts by weight of LiNi_{0.80}CO_{0.15}Al_{0.05}O₂ serving as the positive electrode active material, 4 parts by weight of polyvinylidene fluoride (PVDF) serving as the binder was added, and mixed with an appropriate amount of N-methyl-2-pyrrolidone (NMP), to prepare a positive electrode material mixture slurry. The prepared positive electrode material mixture slurry was applied onto both surfaces of a 20-μm-thick aluminum foil serving as the positive electrode core material by using a die coater, and the applied film was dried and then rolled, whereby a positive electrode material mixture layer was formed. The positive electrode material mixture layer was cut together with the positive electrode core material into a predetermined shape, to produce a positive electrode.

### (c) Preparation of Non-Aqueous Electrolyte

LiPF₆ was dissolved at a concentration of 1 mol/liter in a mixed solvent containing ethylene carbonate (EC), propylene carbonate (PC), and diethyl carbonate (DEC) at a weight ratio of 1:5:4, to prepare a non-aqueous electrolyte. To the non-aqueous electrolyte, 1.5% by weight of vinylene carbonate (VC) and 1.5% by weight of 1,3-propane sultone were added. The viscosity of the non-aqueous electrolyte at 25° C. measured with a rotational viscometer was 5.4 cP.

### (d) Fabrication of Battery

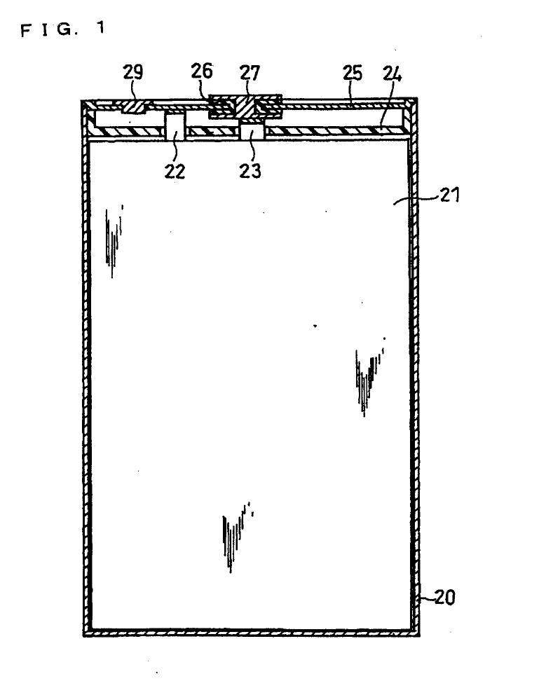

A prismatic lithium ion secondary battery as shown in FIG. 1 was fabricated.

The negative electrode and the positive electrode were wound with a separator of a polyethylene microporous film having a thickness of 20 μm (A089 (trade name) available from Celgard, LLC.) interposed therebetween, to form an electrode assembly 21 having an approximate elliptic cross section. The electrode assembly 21 was encased in a prismatic battery can 20 made of aluminum. The battery can 20 had a bottom and a side wall, and has an approximate square opening at the top. The main flat portion of the side wall was 80 μm in thickness. Then, an insulator 24 for preventing short circuit between the battery can 20 and a positive electrode lead 22 or a negative electrode lead 23 was disposed on top of the electrode assembly 21. Next, a square sealing plate 25 having at its center a negative electrode terminal 27 surrounded by an insulating gasket 26 was arranged at the opening of the battery can 20. The negative electrode lead 23 was connected to the negative electrode terminal 27. The positive electrode lead 22 was connected to the lower surface of the sealing plate 25. The edge of the opening and the sealing plate 25 were welded together by a laser, to seal the opening of the battery can 20. Subsequently, 2.5 g of the non-aqueous electrolyte was injected into the battery can 20 through an injection port of the sealing plate 25. Finally, the injection port was closed with a sealing stopper 29 and sealed by welding, to complete the prismatic lithium ion secondary battery 1 having a height of 50 mm and a width of 34 mm, including an internal space of about 5.2 mm in thickness, and having a design capacity of 850 mAh.

<Evaluation of Battery>

### (i) Evaluation of Cycle Capacity Retention Rate

The battery 1 was subjected to repeated charge/discharge cycles at 45° C. In each charge/discharge cycle, charging was performed as follows: first, a constant current charge was performed at a charge current of 600 mA with a cut-off voltage of 4.2 V, and then, a constant voltage charge was performed at 4.2 V until the current reached an end-of-charge current of 43 mA. The battery was allowed to stand after charging for 10 minutes. In discharging, a constant current discharge was performed at a discharge current of 850 mA with a discharge cut-off voltage of 2.5 V. The battery was allowed to stand after discharging for 10 minutes.

Assuming that the discharge capacity at the 3rd cycle was 100%, the percentage of the discharge capacity after 500 cycles relative to that at the 3rd cycle was calculated as a cycle capacity retention rate (%). The result is shown in Table 1.

### (ii) Evaluation of Battery Swelling

The thicknesses of the center portion of the battery 1 perpendicular to the cross-sectional face (longitudinal length: 50 mm, lateral length: 34 mm) in the state after charging at the 3rd cycle and in the state after charging at the 501th cycle were measured. The difference between the measured battery thicknesses was calculated as a battery swelling amount (mm) after charge/discharge cycles at 45° C. The result is shown in Table 1.

(iii) Low-Temperature Discharge Characteristic Evaluation

The battery 1 was subjected to three battery charge/discharge cycles at 25° C. In the 4th charge/discharge cycle, the battery was charged at 25° C., then allowed to stand for 3 hours at 0° C., and discharged at 0° C. Assuming that the discharge capacity at the 3rd cycle (at 25° C.) was 100%, the percentage of the discharge capacity at the 4th cycle (at 0° C.) relative to that at the 3rd cycle was calculated as a low-temperature discharge capacity retention rate (%). The result is shown in Table 1. Here, the conditions for charging and discharging were the same as those in (i), except for the length of time during which the battery was allowed to stand after charging.

### Example 2

Non-aqueous electrolytes were prepared in the same manner as in Example 1, except that the ratio of W_{EC}:W_{PC}:W_{DEC} was changed as shown in Table 1. Batteries 2 to 18 were fabricated in the same manner as in Example 1, except that the obtained non-aqueous electrolytes were used. It should be noted that the batteries 2, 3, 9, 10 and 15 to 18 are comparative batteries.

The batteries 2 to 18 were evaluated in the same manner as in Example 1. The results are shown in Table 1.

TABLE 1

| | | | | | Low- |
|---|---|---|---|---|---|
| | | | | | temperature |
| | | | Cycle | Battery | discharge |
| | | | capacity | swelling | capacity |
| | | Vis- | retention | after | retention |
| | | cosity | rate | cycling | rate |
| | W_{EC}:W_{PC}:W_{DEC} | (cP) | (%) | (mm) | (%) |
| Battery 1 | 10:50:40 | 5.4 | 86.4 | 0.30 | 74.2 |
| Battery 2 | 10:20:70 | 4.0 | 57.0 | 1.10 | 74.4 |
| Battery 3 | 10:25:65 | 4.3 | 58.3 | 1.03 | 74.3 |
| Battery 4 | 10:30:60 | 4.5 | 80.9 | 0.58 | 74.5 |
| Battery 5 | 10:35:55 | 4.8 | 83.0 | 0.43 | 74.5 |
| Battery 6 | 10:40:50 | 5.0 | 86.0 | 0.34 | 74.3 |
| Battery 7 | 10:55:35 | 5.7 | 84.1 | 0.39 | 72.9 |
| Battery 8 | 10:60:30 | 5.9 | 81.2 | 0.50 | 70.3 |
| Battery 9 | 10:65:25 | 6.4 | 58.5 | 1.02 | 55.7 |
| Battery 10 | 3:32:65 | 4.3 | 56.1 | 1.17 | 53.0 |
| Battery 11 | 5:30:65 | 4.2 | 81.0 | 0.56 | 72.1 |
| Battery 12 | 15:35:50 | 4.9 | 82.9 | 0.44 | 74.4 |
| Battery 13 | 15:40:45 | 5.2 | 85.6 | 0.35 | 74.0 |
| Battery 14 | 20:45:35 | 5.6 | 80.7 | 0.59 | 71.8 |
| Battery 15 | 25:45:30 | 5.8 | 53.8 | 1.22 | 54.6 |
| Battery 16 | 40:20:40 | 5.3 | 46.3 | 1.31 | 50.3 |
| Battery 17 | 50:0:50 | 5.0 | 35.5 | 1.40 | 67.6 |
| Battery 18 | 50:50:0 | 7.7 | 38.9 | 1.37 | 38.0 |

From Table 1, the batteries using the non-aqueous electrolytes in which the weigh percentage W_{PC} of PC was 30 to 60% by weight and the W_{C}/W_{SL}, was 1.0 were excellent in the cycle capacity retention rate and the low-temperature discharge capacity retention rate. In addition, the battery swelling after cycling of these batteries was small, indicating that the amount of generated gas was small. The batteries using the non-aqueous electrolytes in which the ratio W_{PC}/W_{EC} of the weight percentage W_{PC} of PC to the weight percentage W_{EC} of EC satisfied 2.25≦W_{PC}/W_{EC}≦6 were more excellent in the cycle capacity retention rate and the low-temperature discharge capacity retention rate. In addition, the battery swelling after cycling was further small, indicating that the amount of generated gas was very small.

The batteries using the non-aqueous electrolyte in which no PC was contained or the weight percentage of PC was less than 30% by weight generated a large amount of gas such as CO, CO₂, CH₄, and C₂H₆, and exhibited an increased battery swelling after cycling at a high temperature and a reduced cycle capacity retention rate. This is presumably because the amounts of DEC and EC in the non-aqueous solvent became relatively large, and therefore, the oxidative decomposition and reductive decomposition of DEC and the oxidative decomposition of EC occurred at the positive electrode and the negative electrode.

The battery using the non-aqueous electrolyte in which the weight percentage of PC exceeded 60% by weight generated a large amount of gas such as CH₄, C₃H₆, and C₃H₈, and exhibited an increased battery swelling after cycling at a high temperature and a reduced cycle capacity retention rate. This is presumably because the reductive decomposition of PC occurred at the negative electrode.

In the battery using the non-aqueous electrolyte in which the weight percentage of EC was less than 5% by weight, the low-temperature discharge capacity retention rate tended to reduce. This is presumably because the surface film derived from EC was not sufficiently formed on the negative electrode, causing lithium ions to be less likely to be absorbed or desorbed to and from the negative electrode. It is also presumable that the insufficient formation of the surface film on the negative electrode facilitated the reductive decomposition of PC, resulted in a reduced cycle capacity retention rate and an increased battery swelling.

In the batteries using the non-aqueous electrolytes in which the weight percentage of EC exceeded 20% by weight, the battery swelling after cycling at a high temperature was increased and the cycle capacity retention rate was reduced presumably because the oxidative decomposition of EC occurred at the positive electrode, and a large amount of gas such as CO and CO₂ was generated. Further, the low-temperature discharge capacity retention rate was reduced presumably because the viscosity of the non-aqueous electrolyte increased.

### Example 3

Non-aqueous electrolytes were prepared in the same manner as in Example 1, except that the total additive amount was adjusted to 3.0% by weight, and the W_{C}/W_{SL} was changed as shown in Table 2. Batteries 19 to 29 were fabricated in the same manner as in Example 1, except that the obtained non-aqueous electrolytes were used. It should be noted that the batteries 19 to 22 and 29 are comparative batteries.

The batteries 19 to 29 were evaluated in the same manner as in Example 1. The results are shown in Table 2.

TABLE 2

| | | | | Low- |
|---|---|---|---|---|
| | | | | temperature |
| | | Cycle | Battery | discharge |
| | | capacity | swelling | capacity |
| | | retention | after | retention |
| | | rate | cycling | rate |
| | W_{c}/W_{SL} | (%) | (mm) | (%) |
| Battery 19 | 0.01 | 40.1 | 0.88 | 43.2 |
| Battery 20 | 0.05 | 52.9 | 0.84 | 45.0 |
| Battery 21 | 0.1 | 64.1 | 0.79 | 51.7 |
| Battery 22 | 0.3 | 68.4 | 0.77 | 55.2 |
| Battery 23 | 0.5 | 81.1 | 0.51 | 72.5 |
| Battery 24 | 0.75 | 86.2 | 0.31 | 73.7 |
| Battery 1 | 1.0 | 86.4 | 0.30 | 74.2 |
| Battery 25 | 1.5 | 86.0 | 0.34 | 74.5 |
| Battery 26 | 2.0 | 84.3 | 0.42 | 74.4 |
| Battery 27 | 2.5 | 82.5 | 0.49 | 74.2 |
| Battery 28 | 3.0 | 81.0 | 0.57 | 74.1 |
| Battery 29 | 3.5 | 66.5 | 0.88 | 73.6 |

From Table 2, the batteries using the non-aqueous electrolytes in which the ratio W_{C}/W_{SL} of the weight percentage W_{C} of the cyclic carbonate (VC) having a C═C unsaturated bond to the weight percentage W_{SL}, of the sultone compound (PS) satisfied 0.5≦W_{C}/W_{SL}≦3.0 were particularly excellent in the cycle capacity retention rate and the low-temperature discharge capacity retention rate. In addition, the battery swelling after cycling was further small.

In the batteries using the non-aqueous electrolytes in which the W_{C}/W_{SL} was less than 0.5, the cycle characteristics and the low-temperature discharge capacity retention rate tended to reduce. This is presumably because the charge acceptance deteriorated, and the resistance of the surface film on the negative electrode increased.

The battery using the non-aqueous electrolyte in which the W_{C}/W_{SL} exceeded 3.0 exhibited an increased battery swelling after cycling and a reduced cycle capacity retention rate presumably because a larger amount of gas was generated as a result of oxidative decomposition of VC.

### Example 4

Non-aqueous electrolytes were prepared in the same manner as in Example 1, except that the W_{C}/W_{SL} in the additive was adjusted to 1.0, and the total additive amount was changed as shown in Table 3. Batteries 30 to 35 were fabricated in the same manner as in Example 1, except that the obtained non-aqueous electrolytes were used.

The batteries 30 to 35 were evaluated in the same manner as in Example 1. The results are shown in Table 3.

TABLE 3

| | | | | Low- |
|---|---|---|---|---|
| | | | | temperature |
| | | Cycle | Battery | discharge |
| | | capacity | swelling | capacity |
| | Total | retention | after | retention |
| | amount | rate | cycling | rate |
| | (wt %) | (%) | (mm) | (%) |
| Battery 30 | 1.0 | 80.0 | 0.58 | 74.3 |
| Battery 31 | 1.5 | 83.5 | 0.44 | 74.5 |
| Battery 32 | 2.0 | 85.8 | 0.34 | 74.0 |
| Battery 1 | 3.0 | 86.4 | 0.30 | 74.2 |
| Battery 33 | 4.0 | 86.0 | 0.33 | 72.3 |
| Battery 34 | 5.0 | 83.3 | 0.46 | 71.7 |
| Battery 35 | 6.0 | 80.1 | 0.59 | 70.0 |

From Table 3, the batteries using the non-aqueous electrolytes in which the ratio W_{C}/W_{SL} of the weight percentage W_{C} of the cyclic carbonate (VC) having a C═C unsaturated bond to the weight percentage W_{SL} of the sultone compound (PS) was 1.0 were excellent in the cycle capacity retention rate and the low-temperature discharge capacity retention rate. In addition, the battery swelling after cycling was small.

Among these, the batteries using the non-aqueous electrolyte in which the additive amount was 1.5 to 5.0% by weight exhibited a smaller battery swelling and more excellent cycle characteristics. The batteries using the non-aqueous electrolyte in which the additive amount was 2.0 to 4.0% by weight exhibited a further smaller battery swelling and highly excellent characteristics.

### Example 5

Batteries 36 to 39 were fabricated in the same manner as in Example 1, except that the water-soluble polymers shown in Table 4 were used. The water-soluble polymers used had a molecular weight of about 400,000.

The batteries 36 to 39 were evaluated in the same manner as in Example 1. The results are shown in Table 4.

TABLE 4

| | | | | Low- |
|---|---|---|---|---|
| | | | | temperature |
| | | Cycle | Battery | discharge |
| | | capacity | swelling | capacity |
| | | retention | after | retention |
| | Water-soluble | rate | cycling | rate |
| | polymer | (%) | (mm) | (%) |
| Battery 36 | CMC | 86.4 | 0.30 | 74.2 |
| Battery 37 | Na salt of CMC | 82.1 | 0.42 | 74.3 |
| Battery 38 | Methylcellulose | 81.7 | 0.48 | 73.6 |
| Battery 39 | Polyacrylic acid | 86.5 | 0.31 | 74.5 |

From Table 4, the batteries in which the surfaces of the graphite particles included in the negative electrode were coated with a water-soluble polymer were excellent in the cycle capacity retention rate and the low-temperature discharge capacity retention rate. In addition, the battery swelling after cycling was small.

### Example 6

Batteries 40 and 41 were fabricated in the same manner as in Example 1, except that the positive electrode active materials shown in Table 5 were used.

The batteries 40 and 41 were evaluated in the same manner as in Example 1. The results are shown in Table 5.

### Comparative Example 1

A non-aqueous electrolyte was prepared in the same manner as in Example 1, except that a mixed solvent containing EC and DEC at a weight ratio of 5:5 and containing no PC. A battery 42 was fabricated in the same manner as in Example 1 except that the obtained non-aqueous electrolyte was used.

Batteries 43 and 44 were fabricated in the same manner as the battery 42, except that the positive electrode active materials shown in Table 5 were used.

The batteries 42 to 44 were evaluated in the same manner as in Example 1. The results are shown in Table 5.

TABLE 5

| | | | | | Low- |
|---|---|---|---|---|---|
| | | | | | temperature |
| | | | Cycle | Battery | discharge |
| | | | capacity | swelling | capacity |
| | | | retention | after | retention |
| | | Positive electrode | rate | cycling | rate |
| | W_{EC}:W_{PC}:W_{DEC} | active material | (%) | (mm) | (%) |
| Battery 1 | 10:50:40 | LiNi_{0.80}Co_{0.15}Al_{0.05}O₂ | 86.4 | 0.30 | 74.2 |
| Battery 40 | 10:50:40 | LiNi_{1/3}Co_{1/3}Al_{1/3}O₂ | 85.8 | 0.33 | 74.0 |
| Battery 41 | 10:50:40 | LiCoO₂ | 85.7 | 0.35 | 74.2 |
| Battery 42 | 50:0:50 | LiNi_{0.80}Co_{0.15}Al_{0.05}O₂ | 35.5 | 1.40 | 67.6 |
| Battery 43 | 50:0:50 | LiNi_{1/3}Co_{1/3}Al_{1/3}O₂ | 48.9 | 1.02 | 67.3 |
| Battery 44 | 50:0:50 | LiCoO₂ | 64.4 | 0.72 | 68.5 |

From Table 5, the batteries using the non-aqueous electrolytes in which the ratio of the weight percentages of EC, PC and DEC was 1:5:4 were excellent in the cycle capacity retention rate and the low-temperature discharge capacity retention rate, regardless of which positive electrode active material was used. In addition, the battery swelling after cycling was small, indicating that the amount of generated gas was small.

Comparison of the above batteries with the batteries using the non-aqueous electrolytes in which the ratio of the weight percentages of EC and DEC was 5:5 shows that in the batteries using a lithium-nickel-containing positive electrode active material, in particular, the reduction rate of the battery swelling, that is, the reduction rate of gas generation, was high.

### Comparison Example 2

A non-aqueous electrolyte was prepared in the same manner as in Example 1, except that no additive was used. A battery 45 was fabricated in the same manner as in Example 1 except that the obtained non-aqueous electrolyte was used.

### Comparison Example 3

A non-aqueous electrolyte was prepared in the same manner as in Example 1, except that an additive including vinylene carbonate (VC) only was used. A battery 46 was fabricated in the same manner as in Example 1 except that the obtained non-aqueous electrolyte was used.

### Comparison Example 4

A non-aqueous electrolyte was prepared in the same manner as in Example 1, except that an additive including 1,3-propane sultone (PS) only was used. A battery 47 was fabricated in the same manner as in Example 1 except that the obtained non-aqueous electrolyte was used.

The batteries 45 and 47 were evaluated in the same manner as in Example 1. The results are shown in Table 6.

TABLE 6

| | | | | | Low- |
|---|---|---|---|---|---|
| | | | | | temperature |
| | | | | Battery | discharge |
| | | | | swelling | capacity |
| | VC | PS | Cycle capacity | after | retention |
| | amount | amount | retention rate | cycling | rate |
| | (wt %) | (wt %) | (%) | (mm) | (%) |
| Battery 45 | 0% | 0% | charge/discharge | — | — |
| | | | impossible | | |
| Battery 46 | 1.5% | 0% | 26.8 | 2.30 | 74.3 |
| Battery 47 | 0% | 1.5% | 64.1 | 0.79 | 52.2 |

As shown in Table 6, in the battery using the non-aqueous electrolyte containing neither VC nor PS, reductive decomposition of PC occurred vigorously, and therefore, performing charging and discharging was impossible.

In the battery using the non-aqueous electrolyte containing VC only as the additive, the battery swelling was abnormally increased, and the cycle capacity retention rate was low. This is presumably because not only the reductive decomposition of PC was not sufficiently inhibited, but also the oxidative decomposition of VC itself occurred, resulting in a generation of a large amount of gas.

In the battery using the non-aqueous electrolyte containing PS only as the additive, the low-temperature discharge capacity retention rate was low presumably because the resistance of the surface film on the negative electrode increased. Further, the cycle capacity retention rate was also low presumably because the charge acceptance deteriorated.

### Example 7

Negative electrodes were produced in the same manner as in Example 1, except that the CMC amount in the dry mixture per 100 parts by weight of the graphite particles and the penetration rate of water into the negative electrode material mixture layer were changed as shown in Table 7. The CMC amount per 100 parts by weight of the graphite particles was changed by changing the CMC concentration in the CMC aqueous solution. Batteries 48 and 55 were fabricated in the same manner as in Example 1, except that the negative electrodes thus produced were used. It should be noted that the batteries 55 is a comparative battery.

The batteries 48 and 55 were evaluated in the same manner as in Example 1. The results are shown in Table 7.

TABLE 7

| | | Penetration | | | Low- |
|---|---|---|---|---|---|
| | | rate of water | | | temperature |
| | | into negative | Cycle | Battery | discharge |
| | | electrode | capacity | swelling | capacity |
| | CMC | material | retention | after | retention |
| | amount | mixture layer | rate | cycling | rate |
| | (wt %) | (sec) | (%) | (mm) | (%) |
| Battery 48 | 0.2 | 3 | 80.3 | 0.56 | 71.2 |
| Battery 49 | 0.4 | 5 | 82.9 | 0.44 | 75.1 |
| Battery 50 | 0.7 | 10 | 85.6 | 0.35 | 75.5 |
| Battery 1 | 1.0 | 15 | 86.4 | 0.30 | 71.2 |
| Battery 51 | 1.2 | 20 | 85.3 | 0.33 | 73.9 |
| Battery 52 | 1.5 | 25 | 84.4 | 0.37 | 73.4 |
| Battery 53 | 2.0 | 30 | 82.1 | 0.42 | 72.7 |
| Battery 54 | 2.8 | 40 | 80.5 | 0.59 | 71.3 |
| Battery 55 | 3.7 | 50 | 72.2 | 0.71 | 67.9 |

As shown in Table 7, the battery 55 in which the CMC amount per 100 parts by weight of the graphite particles was 3.7% by weight exhibited an increased water penetration rate. This is presumably because the negative electrode active material was excessively coated with the water-soluble polymer. Further, it is presumed that because of the excessive coating of the graphite particles, the charge acceptance of the negative electrode deteriorated, causing the battery swelling to be increased and the cycle capacity retention rate to be reduced.

In the present invention, since the weight percentage of the propylene carbonate is set to be relatively high, the gas generation caused by the oxidative decomposition or reductive decomposition of the linear carbonate or other cyclic carbonate can be greatly suppressed. Further, because of the low melting point of the propylene carbonate, the non-aqueous electrolyte of the present invention hardly freezes even in a low temperature environment. This improves the low-temperature characteristics of the non-aqueous electrolyte secondary battery.

The propylene carbonate has good suitability with a certain kind of negative electrode material. For example, when graphite particles coated with a water-soluble polymer are used as the negative electrode active material, the decomposition of the propylene carbonate is remarkably suppressed, and thus the deterioration of the negative electrode hardly occurs.

The weight percentage W_{EC} of the ethylene carbonate is preferably 5 to 20% by weight, and weight percentage W_{DEC} of the diethyl carbonate is preferably 30 to 65% by weight.

The cyclic carbonate having a C═C unsaturated bond is preferably at least one selected from the group consisting of vinylene carbonate, vinylethylene carbonate, and divinylethylene carbonate.

The sultone compound is preferably at least one of 1,3-propane sultone and 1,4-butane sultone.

The additive is included in the non-aqueous electrolyte preferably in an amount of 1.5 to 5% by weight.

The viscosity at 25° C. of the non-aqueous electrolyte of the present invention is, for example, 4.0 to 6.5 cP.

In the non-aqueous electrolyte secondary battery of the present invention, the water-soluble polymer preferably includes a cellulose derivative or polyacrylic acid.

The penetration rate of water into the negative electrode material mixture layer is preferably 3 to 40 seconds.

The positive electrode preferably includes a composite oxide represented by the general formula:

LiₓNi_{y}M_{z}Me_{1-(y+z)}O_{2+d},

where M is at least one element selected from the group consisting of Co and Mn; Me is at least one element selected from the group consisting of Al, Cr, Fe, Mg and Zn, 0.98≦x≦1.1, 0.3≦y≦1, 0≦z ≦0.7, 0.9≦(y+z)≦1, and −0.01≦d≦0.01.

### INDUSTRIAL APPLICABILITY

By using the non-aqueous electrolyte of the present invention in a non-aqueous electrolyte secondary battery, it is possible to suppress the reduction in capacity during storage and capacity during charge/discharge cycling of the battery in a high temperature environment, as well as to achieve excellent low-temperature characteristics of the battery. The non-aqueous electrolyte secondary battery of the present invention is useful for cellular phones, personal computers, digital still cameras, game machines, portable audio equipment, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

20 Battery can
21 Electrode assembly
22 Positive electrode lead
23 Negative electrode lead
24 Insulator
25 Sealing plate
26 Insulating gasket
29 Sealing stopper

1. A non-aqueous electrolyte comprising a non-aqueous solvent and a solute dissolved in the non-aqueous solvent, wherein
the non-aqueous solvent includes ethylene carbonate, propylene carbonate, diethyl carbonate, and an additive,
the additive includes a sultone compound and a cyclic carbonate having a C═C unsaturated bond,
a weight percentage W_{PC} of the propylene carbonate relative to a total of the ethylene carbonate, the propylene carbonate, and the diethyl carbonate is 30 to 60% by weight,
a ratio W_{PC}/W_{EC} of the weight percentage W_{PC} of the propylene carbonate to a weight percentage W_{EC} of the ethylene carbonate relative to the total satisfies 2.25≦W_{PC}/W_{EC}≦6, and
a ratio W_{C}/W_{SL} of a weight percentage W_{C} of the cyclic carbonate having a C═C unsaturated bond to a weight percentage W_{SL}, of the sultone compound satisfies 0.5≦W_{C}/W_{SL}≦3.

2. The non-aqueous electrolyte in accordance with claim 1, wherein the weight percentage W_{EC} of the ethylene carbonate is 5 to 20% by weight, and a weight percentage W_{DEC} of the diethyl carbonate is 30 to 65% by weight.

3. The non-aqueous electrolyte in accordance with claim 1, wherein the cyclic carbonate having a C═C unsaturated bond is at least one selected from the group consisting of vinylene carbonate, vinylethylene carbonate, and divinylethylene carbonate.

4. The non-aqueous electrolyte in accordance with claim 1, wherein the sultone compound is at least one of 1,3-propane sultone and 1,4-butane sultone.

5. The non-aqueous electrolyte in accordance with claim 1, wherein the additive is contained in the non-aqueous electrolyte in an amount of 1.5 to 5% by weight.

6. The non-aqueous electrolyte in accordance with claim 1, wherein the non-aqueous electrolyte has a viscosity at 25° C. of 4 to 6.5 cP.

7. A non-aqueous electrolyte secondary battery obtained by
forming an electrode assembly including a positive electrode, a negative electrode, and a separator,
encasing the electrode assembly in a battery case,
injecting the non-aqueous electrolyte of claim 1 into the battery case with the electrode assembly encased therein, and
sealing the battery case to prepare an initial battery, followed by allowing the initial battery to be subjected to at least one charge/discharge cycle, wherein
the negative electrode includes a negative electrode core material and a negative electrode material mixture layer attached on the negative electrode core material, and
the negative electrode material mixture layer includes graphite particles, a water-soluble polymer coated on a surface of the graphite particles, and a binder providing adhesion between the graphite particles coated with the water-soluble polymer.

8. The non-aqueous electrolyte secondary battery in accordance with claim 7, wherein the water-soluble polymer includes a cellulose derivative or polyacrylic acid.

9. The non-aqueous electrolyte secondary battery in accordance with claim 7, wherein a penetration rate of water into the negative electrode material mixture layer is 3 to 40 seconds.

10. The non-aqueous electrolyte secondary battery in accordance with claim 7, wherein the positive electrode includes a composite oxide represented by a general formula:
LiₓNi_{y}M_{z}Me_{1-(y+z)}O_{2+d},
where M is at least one element selected from the group consisting of Co and Mn; Me is at least one element selected from the group consisting of Al, Cr, Fe, Mg and Zn, 0.98x≦1.1, 0.3≦y≦1, 0≦z≦0.7, 0.9≦(y+z)≦1, and −0.01≦d≦0.01.
